(19) United States
(12) Patent Application Publication
(10) Pub. No.: US 2023/0266067 A1
(43) Pub. Date: Aug. 24, 2023

(54) HEAT-EXCHANGE ELEMENT AND HEAT-EXCHANGE VENTILATION APPARATUS

(71) Applicant: Mitsubishi Electric Corporation, Chiyoda-ku, Tokyo (JP)

(72) Inventors: Fumiyasu MIYAKE, Tokyo (JP); Keiko SHIBATA, Tokyo (JP); Hajime SOTOKAWA, Tokyo (JP)

(73) Assignee: Mitsubishi Electric Corporation, Chiyoda-ku, Tokyo (JP)

(21) Appl. No.: 18/004,187

(22) PCT Filed: Jul. 13, 2020
(86) PCT No.: PCT/JP2020/027272

§ 371 Date: Jan. 4, 2023

(51) Int. Cl. F28D 9/00; F28F 9/02

(52) U.S. Cl. CPC F28D 9/0037; F28D 9/0068; F28F 9/0268

(57) ABSTRACT

The extending direction of a fifth rib that is one of a plurality of first ribs of a first header portion is closer to the extending direction of flow paths in a first counter-flow portion than the extending direction of a sixth rib that is a rib of the plurality of first ribs closer to a fourth edge than the fifth rib. The extending direction of a seventh rib that is one of a plurality of second ribs of a second header portion is closer to the extending direction of the flow paths in the first counter-flow portion than the extending direction of an eighth rib that is a rib of the plurality of second ribs closer to a sixth edge than the seventh rib.

### FIELD

The present disclosure relates to a heat-exchange element that performs heat exchange by allowing two fluids to pass through between stacked plates and a heat-exchange ventilation apparatus.

### BACKGROUND

Flow forms of two-fluid heat exchange used in heat-exchange elements of this type include a cross-flow form in which two fluids flow perpendicularly to each other and a counter-flow form in which two fluids flow in opposite directions, facing each other. Under the same conditions of pressure loss, the amount of heat exchange per unit volume is theoretically larger in the counter-flow form.

A counter-flow heat-exchange element typically includes a counter-flow portion that performs heat exchange, and header portions that change the directions of a supply air current and an exhaust air current to opposite directions in the counter-flow portion between inlet and outlet ports and the counter-flow portion. Patent Literature 1 includes a central portion corresponding to the counter-flow portion and end portions corresponding to the header portions. The end portions include a plurality of equidistant parallel flow paths from the inlet and outlet ports toward the central portion.

### CITATION LIST

### Patent Literature

Patent Literature 1US 2017/0370609 A

### SUMMARY

### Technical Problem

In Patent Literature 1, since the end portions have the plurality of equidistant parallel flow paths from the inlet and outlet ports toward the central portion, air currents in the end portions are not uniform flows, resulting in large pressure loss and causing flow stagnation.

The present disclosure has been made in view of the above. It is an object of the present disclosure to provide a heat-exchange element that can reduce pressure loss in header portions and allows air currents to uniformly flow into a counter-flow portion, and a heat-exchange ventilation apparatus.

### Solution to Problem

To solve the above-described problem and achieve the object, a heat-exchange element of the present disclosure includes hexagonal first partition plates and hexagonal second partition plates stacked alternately, a plurality of first flow paths that are each formed between a front surface of one of the first partition plates and a back surface of an adjacent one of the second partition plates and through each of which air flows from a first inlet to a first outlet, and a plurality of second flow paths that are each formed between a back surface of one of the first partition plates and a front surface of an adjacent one of the second partition plates and through each of which air flows from a second inlet to a second outlet Each of the first partition plates includes a first counter-flow portion disposed in a region sandwiched between a first edge and a second edge that are opposite edges of a hexagon, the first counter-flow portion including a plurality of third flow paths extending in parallel to the first edge and the second edge, a first header portion disposed in a region enclosed by a third edge and a fourth edge of the hexagon disposed on one side of the first edge and the second edge and the first counter-flow portion, the first header portion including a plurality of first ribs extending from the third edge that is an edge adjacent to the first edge, of the third edge and the fourth edge, along the fourth edge toward the first counter-flow portion, and a second header portion disposed in a region enclosed by a fifth edge and a sixth edge of the hexagon disposed on the opposite aide of the first edge and the second edge and the first counter-flow portion, the second header portion including a plurality of second ribs extending from the fifth edge that is an edge adjacent to the second edge, of the fifth edge and the sixth edge, along the sixth edge toward the first counter-flow portion. Each of the second partition plates includes a second counter-flow portion disposed in a region sandwiched between a seventh edge and an eighth edge that are opposite edges of a hexagon, the second counter-flow portion including a plurality of fourth flow paths extending in parallel to the seventh edge and the eighth edge, a third header portion disposed in a region enclosed by a ninth edge and a tenth edge of the hexagon disposed on one side of the seventh edge and the eighth edge and the second counter-flow portion, the third header portion including a plurality of third ribs extending frost the tenth edge that is an edge adjacent to the eighth edge, of the ninth edge and the tenth edge, along the ninth edge toward the second counter-flow portion, and a fourth header portion disposed in a region enclosed by an eleventh edge and a twelfth edge of the hexagon disposed on the opposite side of the seventh edge and the eighth edge and the second counter-flow portion, the fourth header portion including a plurality of fourth ribs extending from the twelfth edge that is an edge adjacent to the seventh edge, of the eleventh edge and the twelfth edge, along the eleventh edge toward the second counter-flow portion. The first partition plates and the second partition plates are stacked alternately such that the first edge is placed on the seventh edge, and the third edge is placed on the ninth edge. The first inlet is a space between the third edge and the ninth edge. The first outlet is a space between the fifth edge and the eleventh edge. The second inlet is a space between the twelfth edge and the sixth edge, the second outlet is a space between the tenth edge and the fourth edge, and the first flow paths are formed by the first ribs, the third flow paths, and the second ribs. The second flow paths are formed by the fourth ribs, the fourth flow paths, and the third ribs. The extending direction of a fifth rib that is one of the plurality of first ribs of the first header portion is closer to the extending direction of the third flow paths than the extending direction of a sixth rib that is a rib of the plurality of first ribs closer to the fourth edge than the fifth rib. The extending direction of a seventh rib that is one of the plurality of second ribs of the second header portion is closer to the extending direction of the third flow paths than the extending direction of an eighth rib that is a rib of the plurality of second ribs closer to the sixth edge than the seventh rib. The extending direction of a ninth rib that is one of the plurality of third ribs of the third header portion is closer to the extending direction of the fourth flow paths than the extending direction of a tenth rib that is a rib of the plurality of third ribs closer to the ninth edge than the ninth rib. The extending direction of an eleventh rib that is one of the plurality of fourth ribs of the fourth header portion is closer to the extending direction of the fourth flow paths than the extending direction of a twelfth rib that is a rib of the plurality of fourth ribs closer to the eleventh edge than the eleventh rib.

### Advantageous Effects of Invention

The present disclosure can reduce pressure loss in the header portions and allows air currents to uniformly flow into the counter-flow portion.

### BRIEF DESCRIPTION OF DRAWINGS

FIG. 1 is an external perspective view illustrating a schematic configuration of a heat-exchange element according to an embodiment.

FIG. 2 is a perspective view illustrating a first partition plate of the heat-exchange element according to the embodiment.

FIG. 3 is a perspective view illustrating a second partition plate of the heat-exchange element according to the embodiment.

FIG. 4 is a cross-sectional view illustrating a stacked state of a first counter-flow portion and a second counter-flow portion of the heat-exchange element according to the embodiment.

FIG. 5 is a plan view illustrating an, arrangement of a plurality of first ribs of a first header portion of the heat-exchange element according to the embodiment.

FIG. 6 is a plan view for explaining, in more detail, end shapes and others of the plurality of first ribs of the first header portion of the heat-exchange element according to the embodiment.

FIG. 7 is a plan view illustrating a positional relationship between a downstream rib and flow paths in the first counter-flow portion of the heat-exchange element according to the embodiment.

FIG. 8 is a plan view illustrating an arrangement of a plurality of second ribs of a second header portion of the heat-exchange element according to the embodiment.

FIG. 9 is a plan view for explaining, in more detail, end shapes and others of the plurality of second ribs of the second header portion of the heat-exchange element according to the embodiment.

FIG. 10 is a diagram illustrating an air velocity distribution in a header portion with a rib arrangement according to a comparative example.

FIG. 11 is a diagram illustrating an air velocity distribution in the first header portion with the rib arrangement according to the present embodiment.

FIG. 12 is a diagram illustrating an air velocity distribution in the first header portion with the rib arrangement according to the present embodiment.

FIG. 13 is a conceptual diagram illustrating a heat-exchange ventilation apparatus in which the heat-exchange element of the present embodiment is installed.

### DESCRIPTION OF EMBODIMENTS

Hereinafter, a heat-exchange element and a heat-exchange ventilation apparatus according to an embodiment will be described in detail with reference to the drawings.

### Embodiment

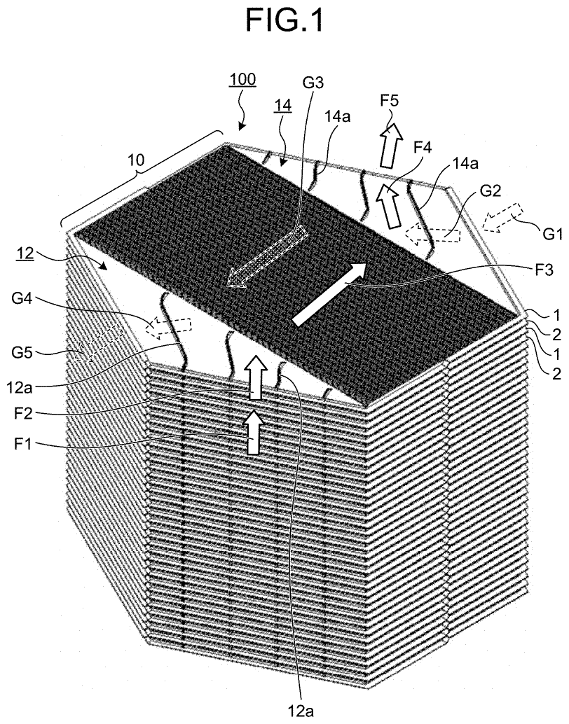

FIG. 1 is an external perspective view illustrating a schematic configuration of a counter-flow heat-exchange element 100 according to the present embodiment. The heat-exchange element 100 is formed in a hexagonal column shape. The heat-exchange element 100 includes a plurality of first partition plates 1 and a plurality of second partition plates 2. The first partition plates 1 and the second partition plates 2 are stacked alternately. The first partition plates 1 and the second partition plates 2 are each formed of a hexagonal sheet of resin, metal, or the like

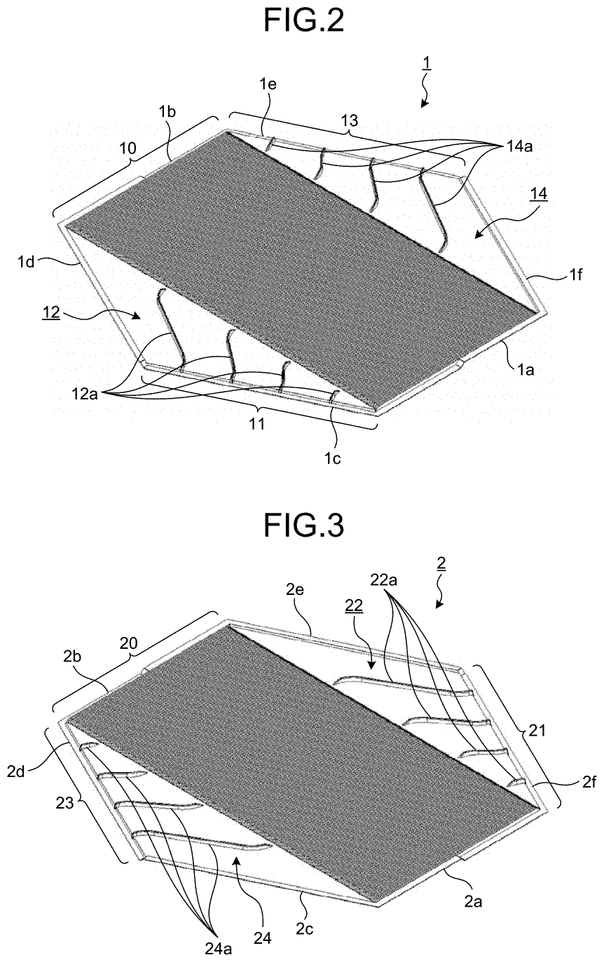

FIG. 1, in which one of the first partition plates 1 is disposed in the top layer, illustrates only the structure of the first partition plates 1 and does not illustrate the structure of the second partition plates 2. The structure of the first partition plates 1 and the structure of the second partition plates 2 will be described later with reference to FIGS. 2 and 3. As illustrated in FIG. 1, first flow paths for which a flow of air is indicated by solid arrows F1, F2, F3, F4, and F5 are formed between the front surface of each first partition plate 1 and the back surface of the adjacent second partition plate 2. Second flow paths for which a flow of air is indicated by dashed arrows G1, G2, G3, G4, and G5 are formed between the back surface of each first partition plate 1 and the front surface of the adjacent second partition plate 2. The front surface of the first partition plate 1 refers to a surface on which ribs (described later) for forming the first flow paths are formed. The back surface of the first partition plate 1 refers to a surface opposite to the front surface The front surface of the second partition plate 2 refers to a surface on which ribs (described later) for forming the second flow paths are formed. The back surface of the second partition plate 2 refers to a surface opposite to the front surface.

FIG. 2 is a perspective view illustrating one of the first partition plates 1 of the heat-exchange element 100 according to the present embodiment. FIG. 2 illustrates a state where the heat-exchange element 100 is viewed from the same direction as in FIG. 1. The first partition plate 1 includes a first counter-flow portion 10 as a heat-exchange portion, a first inlet 11, a first header portion 12 that is a portion connecting the first inlet 11 and the first counter-flow portion 10, a first outlet 13, and a second header portion 14 that is a portion connecting the first outlet 13 and the first counter-flow portion 10. The first partition plate 1 includes six edges 1a, 1b, 1c, 1d, 1e, and 1f. The first counter-flow portion 10 is formed in a region sandwiched between the first edge 1a and the second edge 1b. The third edge 1c and the fourth edge 1d are disposed, for example, on one side of the first edge 1a and the second edge 1b. The fifth edge 1e and the sixth edge 1f are disposed, for example, on the opposite side of the first edge 1a and the second edge 1b. The first header portion 12 in a triangular shape is disposed in a region enclosed by the third edge 1c, the fourth edge 1d, and the first counter-flow portion 10. The second header portion 14 in a triangular shape is disposed in a region enclosed by the fifth edge 1e, the sixth edge 1f, and the first counter-flow portion 10.

Six edge portions of the first partition plate 1 are formed such that openings are formed only at the portion of the third edge 1c corresponding to the first inlet 11 and the portion of the fifth edge 1e corresponding to the first outlet 13, and the portions of the first edge 1a, the second edge 1b, the fourth edge 1d, and the sixth edge 1f are closed when the second partition plate 2 is placed thereon. That is, the portions of the first edge 1a, the second edge 1b, the fourth edge 1d, and the sixth edge 1f are formed, for example, in a rising shape to be closed. In the first partition plate 1 illustrated in FIG. 2, a part (about a half in the illustration) of the first edge 1a adjacent to the third edge 1c is not formed in the rising shape to form an opening. Likewise, a part (about a half in the illustration) of the second edge 1b adjacent to the fifth edge 1e is not formed in the rising shape to form an opening. Furthermore, in a corner area of the first counter-flow portion 10 with the point of intersection of the first edge 1a and the third edge 1c as the corner, a corrugated body 10a as the heat-exchange portion to be described later is not formed. Likewise, in a corner area of the first counter-flow portion 10 with the point of intersection of the second edge 1b and the fifth edge 1e as the corner, the corrugated body 10a as the heat-exchange portion to be described later is not formed.

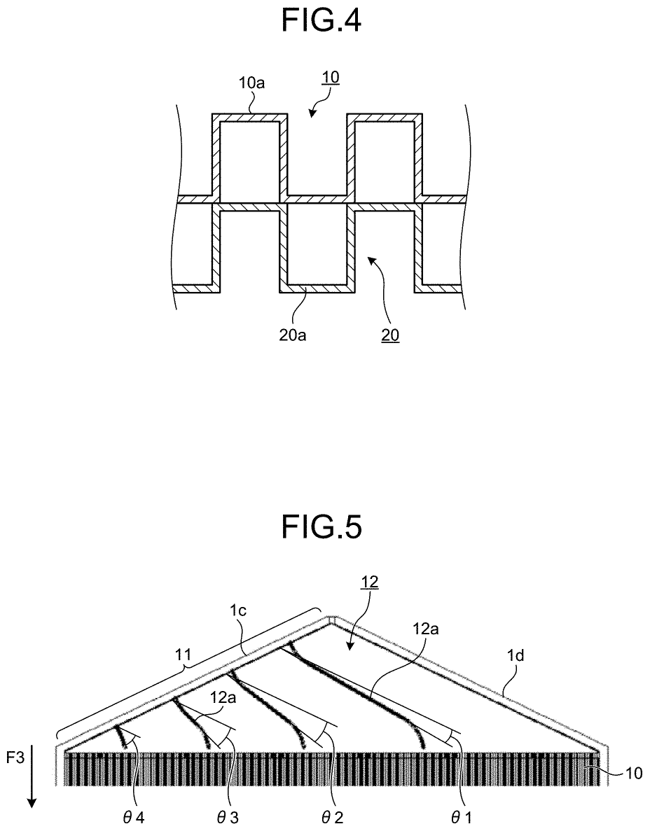

The first counter-flow portion 10 includes a plurality of flow paths extending in parallel to the first edge 1a and the second edge 1b. The plurality of flow paths formed in the first counter-flow portion 10 correspond to third flow paths in the claims. FIG. 4 is a partial cross-sectional view illustrating an example of the first counter-flow portion 10. FIG. 4 illustrates a cross-sectional view with the first edge 1a and the second edge 1b cut perpendicularly, The first counter-flow portion 10 includes the corrugated body 10a having a corrugated shape in which recesses and protrusions are formed alternately and continuously. The plurality of flow paths in the first counter-flow portion 10 as the heat-exchange portion is not limited to the structure of FIG. 4 and may adopt other structures as long as a plurality of flow paths extending in parallel to the first edge 1a and the second edge 1b are formed.

As illustrated in FIG. 2, a plurality of protruded first ribs 12a are formed at intervals on the first header portion 12. A plurality of protruded second ribs 14a are formed at intervals on the second header portion 14. The first ribs 12a and the second ribs 14a are formed by press working, vacuum forming, or the like.

The plurality of first ribs 12a extend from the third edge 1c along the fourth edge 1d toward the first counter-flow portion 10. Each of the plurality of first ribs 12a has an S shape. The closer to the fourth edge 1d the first ribs 12a are, the longer their lengths are. The plurality of second ribs 14a extend from the fifth edge 1e along the sixth edge 1f toward the first counter-flow portion 10. Each of the plurality of second ribs 14a has an S shape. The closer to the sixth edge 1f the second ribs 14a are, the longer their lengths are. Details of the first ribs 12a and the second ribs 14a will be described later.

FIG. 3 is a perspective view illustrating one of the second partition plates 2 of the heat-exchange element 100 according to the embodiment. FIG. 3 illustrates a state where the heat-exchange element 100 is viewed from the same direction as in FIG. 1. The second partition plate 2 includes a second counter-flow portion 20 as a heat-exchange portion, a second inlet 21, a fourth header portion 22 that is a portion connecting the second inlet 21 and the second counter-flow portion 20, a second outlet 23, and a third header portion 24 that is a portion connecting the second outlet 23 and the second counter-flow portion 20. The second partition plate 2 includes six edges 2a, 2b, 2c, 2d, 2e, and 2f. The second counter-flow portion 20 is formed in a region sandwiched between the seventh edge 2a and the eighth edge 2b. The ninth edge 2c and the tenth edge 2d are disposed, for example, on one side of the seventh edge 2a and the eighth edge 2b. The eleventh edge 2e and the twelfth edge 2f are disposed, for example, on the opposite side of the seventh edge 2a and the eighth edge 2b. The third header portion 24 in a triangular shape is disposed in a region enclosed by the ninth edge 2c, the tenth edge 2d, and the second counter-flow portion 20. The fourth header portion 22 in a triangular shape is disposed in a region enclosed by the eleventh edge 2e, the twelfth edge 2f, and the second counter-flow portion 20.

Six edge portions of the second partition plate 2 are formed such that openings are formed only at the portion of the twelfth edge 2f corresponding to the second inlet 21 and the portion of the tenth edge 2d corresponding to the second outlet 23, and the portions of the seventh edge 2a, the eighth edge 2b, the ninth edge 2c, and the eleventh edge 2e are closed when the first partition plate 1 is placed thereon. That is, the portions of the seventh edge 2a, the eighth edge 2b, the ninth edge 2c, and the eleventh edge 2e are formed, for example, in a rising shape to be closed. In the second partition plate 2 illustrated in FIG. 3, a part (about a half in the illustration) of the seventh edge 2a adjacent to the twelfth edge 2f is not formed in the rising shape to form an opening. Likewise, a part (about a half in the illustration) of the eighth edge 2b adjacent to the tenth edge 2d is not formed in the rising shape to form an opening. Furthermore, in a corner area of the second counter-flow portion 20 with the point of intersection of the seventh edge 2a and the twelfth edge 2f as the corner, a corrugated body 20a as the heat-exchange portion to be described later is not formed. Likewise, in a corner area of the second counter-flow portion 20 with the point of intersection of the eighth edge 2b and the tenth edge 2d as the corner, the corrugated body 20a as the heat-exchange portion to be described later is not formed.

The second counter-flow portion 20 includes a plurality of flow paths extending in parallel to the seventh edge 2a and the eighth edge 2b. The plurality of flow paths formed in the second counter-flow portion 20 correspond to fourth flow paths in the claims. As illustrated in FIG. 4, the second counter-flow portion 20 includes the corrugated body 20a having a corrugated shape in which recesses and protrusions are formed alternately and continuously. The plurality of flow paths in the second counter-flow portion 20 as the heat exchange portion is not limited to the structure of FIG. 4 and may adopt other structures as long as a plurality of flow paths extending in parallel to the seventh edge 2a and the eighth edge 2b are formed.

As illustrated in FIG. 3, a plurality of protruded third ribs 24a are formed at intervals on the third header portion 24. A plurality of protruded fourth ribs 22a are formed at intervals on the fourth header portion 22. The third ribs 24a and the fourth ribs 21a are formed by press working, vacuum forming, or the like.

The plurality of third ribs 24a extend from the tenth edge 2d along the ninth edge 2c toward the second counter-flow portion 20. Each of the plurality of third ribs 24a has an inverted S shape. The closer to the ninth edge 2c the third ribs 24a are, the longer their lengths are. The plurality of fourth ribs 22a extend from the twelfth edge 2f along the eleventh edge 2e toward the second counter-flow portion 20. Each of the plurality of fourth ribs 22a has an inverted S shape. The closer to the eleventh edge 2e the fourth ribs 22a are, the longer their lengths are. Details of the third ribs 24a and the fourth ribs 22a will be described later.

In the heat-exchange element 100 according to the embodiment, the first partition plates 1 and the second partition plates 2 are stacked alternately such that the first edge 1a is placed on the seventh edge 2a, and the third edge 1c is placed on the ninth edge 2c. More specifically, furthermore, the second edge 1b is placed on the eighth edge 2b, the fourth edge 1d is placed on the tenth edge 2d, the fifth edge 1e is placed on the eleventh edge 2e, and the sixth edge 1f is placed on the twelfth edge 2f.

By placing the first partition plates 1 and the second partition plates 2 on top of each other, the first inlet 11 is formed between the third edge 1c of the first partition plate 1 and the ninth edge 2c of the second partition plate 2. The first outlet 13 is formed between the fifth edge 1e of the first partition plate 1 and the eleventh edge 2e of the second partition plate 2. The second inlet 21 is formed between the twelfth edge 2f of the second partition plate 2 and the sixth edge 1f of the first partition plate 1. The second outlet 23 is formed between the tenth edge 2d of the second partition plate 2 and the fourth edge 1d of the first partition plate 1.

Further, by placing the first partition plates 1 and the second partition plates 2 on top of each other, the first flow paths indicated by the arrows F1, F2, F3, F4, and F5 illustrated in FIG. 1 are formed by the first ribs 12a, the plurality of flow paths in the first counter-flow portion 10, and the second ribs 14a .Furthermore, the second flow paths indicated by the arrows G1, G2, G3, G4, and G5 illustrated in FIG. 1 are formed by the fourth ribs 22a, the plurality of flow paths in the second counter-flow portion 20, and the third ribs 24a.

As indicated by the arrows F1, F2, F3, F4, and F5 illustrated in FIG. 1, air flown into the first inlet 11 is changed in flow direction to the first counter-flow portion 10 in the first header portion 12 and passes through the first counter-flow portion 10, and is changed in flow direction to the first outlet 13 in the second header portion 14 and is discharged from the first outlet 13. As indicated by the arrows G1, G2, G3, G4, and G5 illustrated in FIG. 1, air flown into the second inlet 21 is changed in flow direction to the second counter-flow portion 20 in the fourth header portion 22 and passes through the second counter-flow portion 20, and is changed in flow direction to the second outlet 23 in the third header portion 24 and is discharged from the second outlet 23. In a portion where the first counter-flow portion 10 is placed on the second counter-flow portion 20, air flows in opposite directions, facing each other, and heat exchange is performed between two fluids.

The first inlet 11, the plurality of first ribs 12a, the plurality of flow paths in the first counter-flow portion 10, the plurality of second ribs 14a, and the first outlet 13, and the second outlet 23, the plurality of third ribs 24a, the plurality of flow paths in the second counter-flow portion 20, the plurality of fourth ribs 22a, and the second inlet 21 are arranged such that the first flow paths indicated by the arrows F1, F2, F3, F4, and F5 and the second flow paths indicated by the arrows G1, G2, G3, G4, and G5 illustrated in FIG. 1 are symmetrical about an axis that connects the point of intersection of the fifth edge 1e and the sixth edge 1f of the first partition plate 1 and the point of intersection of the third edge 1c and the fourth edge 1d of the first partition plate 1.

FIG. 5 is a plan view illustrating an arrangement of the plurality of first ribs 12a of the first header portion 12 that is an inlet-side header. The fourth header portion 22 has the same arrangement. The plurality of first ribs 12a extend in different directions. Of the plurality of first ribs 12a, the extending direction of a rib far from the fourth edge 1d adjacent to the first inlet 11 is closer to the extending direction F3 of the flow paths in the first counter-flow portion 10 than the extending direction of a rib close to the fourth edge 1d. That is, the angle formed by the extending direction of the first rib 12a close to the fourth edge 1d and the extending direction F3 of the flow paths in the first counter-flow portion 10 is smaller than the angle formed by the extending direction of the first rib 12a far from the fourth edge 1d and the extending direction F3 of the flaw paths in the first counter-flow portion 10. In other words, the extending directions of the plurality of first ribs 12a of the first header portion 12 become closer to the extending direction F3 of the flow paths in the first counter-flow portion 10 with increasing distance from the fourth edge 1d. Consequently, in the first header portion 12, the flow path widths of the plurality of flow paths formed by the plurality of first ribs 12a are larger near the first counter-flow portion 10 than near the first inlet 11.

The extending directions of the four first ribs 12a illustrated in FIG. 5 are represented by angles 91 to θ4 with respect to the fourth edge 1d. θ1 is the angle of the first rib 12a closest to the fourth edge 1d, θ2 is the angle of the first rib 12a second closest to the fourth edge 1d, θ3 is the angle of the first rib 12a third closest to the fourth edge 1d, and θ4 is the angle of the first rib 12a farthest from the fourth edge 1d. The relationship θ1<θ2<θ3<θ4 is established among the plurality of first ribs 12a.

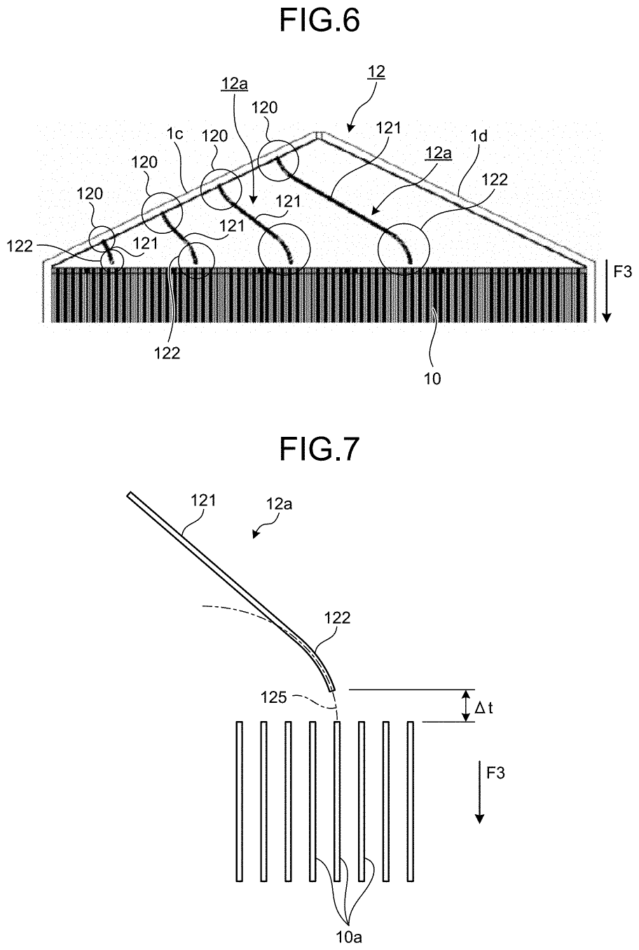

FIG. 6 is a plan view for explaining, in more detail, end shapes and others of the plurality of first ribs 12a of the first header portion 12. Each first rib 12a is composed of an upstream rib 120, a middle rib 121, and a downstream rib 122. The middle rib 121 has a linear shape. The upstream rib 120 has a curved shape that is a single-R shape formed by one arc. The single-R shapes of the upstream ribs 120 of the plurality of first ribs 12a all have the same radius.

Each downstream rib 122 has a curved shape that is a single-R shape formed by one arc. The single-R shapes of the downstream ribs 122 of the plurality of first ribs 12a individually have different radii. The radii of the downstream ribs 122 of the plurality of first ribs 12a increase in curvature with increasing distance from the fourth edge 1d.

When attention is paid to the upstream rib 120 and the downstream rib 122 of one of the first ribs 12a, the curvature of the upstream rib 120 is set to be larger than the curvature of the downstream rib 122.

As described above, the overall shape of the first ribs 12a is almost an S shape including a straight line, in other words, the shape of a letter S elongated lengthwise. The extending directions of the first ribs 12a described above are represented by the extending directions of the middle ribs 121.

The angular differences between the direction of the upstream ends of the upstream ribs 120 and the direction of the downstream ends of the downstream ribs 122 and the extending direction F3 of the flow paths in the first counter-flow portion 10 are smaller than the angular differences between the directions of the middle ribs 121 and the extending direction F3. Specifically, the upstream ends of the upstream ribs 120 are almost perpendicular to the third edge 1c constituting the first inlet 11.

The direction of the downstream end of each downstream rib 122 is at an angle nearly parallel to the extending direction F3 of the flow paths in the first counter-flow portion 10. The relationship between each downstream rib 122 and the flow paths in the first counter-flow portion 10 will be described in more detail with reference to FIG. 7. FIG. 7 is a plan view illustrating a positional relationship between the downstream rib 122 and the flow paths in the first counter-flow portion 10. As illustrated in FIG. 7, the downstream end of the downstream rib 122 does not extend to the first counter-flow portion 10, and faces the upstream edge of the first counter-flow portion 10 across a gap Δt. A virtual extension line 125 of the single-R Shape of the downstream rib 122 touches a straight line indicating the extending direction F3 of the flow paths in the first counter-flow portion 10.

The upstream ribs 120 and the downstream ribs 122, which have been illustrated with the examples of the single-R arc shapes, may each have a curved shape that combines arcs having different radii R. The middle ribs 121, which have been illustrated with the example of the linear shape, may each have a slight curve as long as they are almost linear as a whole.

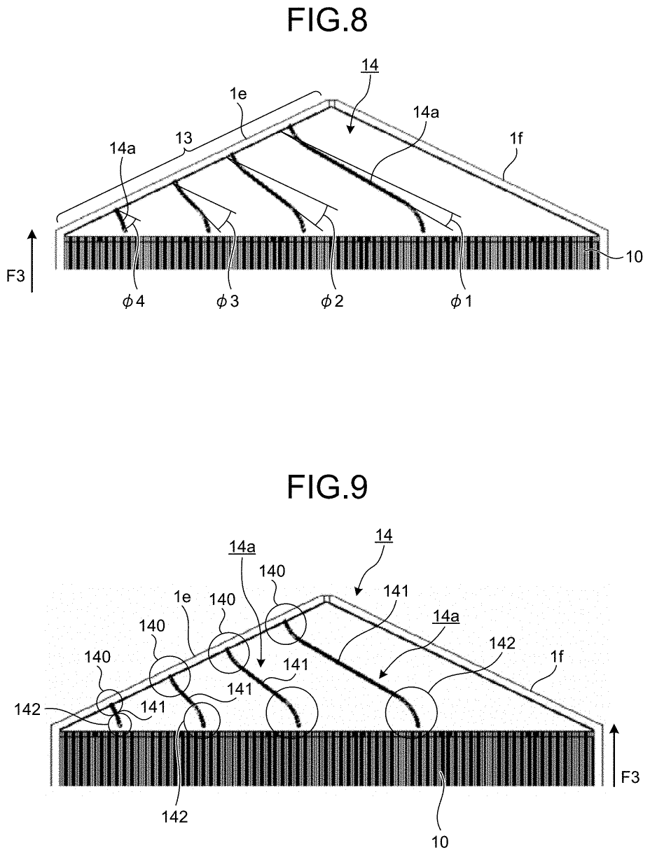

Next, the plurality of second ribs 14a of the second header portion 14 that is an outlet-side header will be described with reference to FIGS. 8 and 9. FIG. 8 is a plan view illustrating an arrangement of the plurality of second ribs 14a of the second header portion 14. The third header portion 24 has the same arrangement- The plurality of second ribs 14a extend in different directions. Of the plurality of second ribs 14a, the extending direction of a rib far from the sixth edge 1f adjacent to the first outlet 13 is closer to the extending direction F3 of the flow paths in the first counter-flow portion 10 than the extending direction of a rib close to the sixth edge 1f. That is, the angle formed by the extending direction of the second rib 14a close to the sixth edge 1f and the extending direction F3 of the flow paths in the first. counter-flow portion 10 is smaller than the angle formed by the extending direction of the second rib 14a far from the sixth edge 1f and the extending direction F3 of the flow paths in the first counter-flow portion 10. In other words, the extending directions of the plurality of second ribs 14a of the second header portion 14 become closer to the extending direction F3 of the flow paths in the first counter-flow portion 10 with increasing distance from the sixth edge 1f. Consequently, in the second header portion 14, the flow path widths of the plurality of flow paths formed by the plurality of second ribs 14a are larger near the first counter-flow portion 10 than near the first outlet 13.

The extending directions of the four second ribs 14a illustrated in FIG, 8 are represented by angles φ1 to φ4 with respect to the sixth edge 1f. φ1 is the angle of the second rib 14a closest to the sixth edge 1f, φ2 is the angle of the second rib 14a second closest to the sixth edge 1f, φ3 is the angle of the second rib 14a third closest to the sixth edge 1f, and φ4 is the angle of the second rib 14a farthest from the sixth edge 1f. The relationship φ1<φ2<φ3<φ4 is established among the plurality of second ribs 14a.

FIG. 9 is a plan view for explaining, in more detail, end shapes and others of the plurality of second ribs 14a of the second header portion 14. Each second rib 14a is composed of a downstream rib 140, a middle rib 141, and an upstream rib 142. The middle rib 141 has a linear shape. The downstream rib 140 has a curved shape that is a single-R shape formed by one arc. The single-R shapes of the downstream ribs 140 of the plurality of second ribs 14a all have the same radius.

Each upstream rib 142 has a curved shape that is a single-R shape formed by one arc. The single-R shapes of the upstream ribs 142 of the plurality of second ribs 14a individually have different radii. The radii of the upstream ribs 142 of the plurality of second ribs 14a increase in curvature with increasing distance from the sixth edge 1f.

When attention is paid to the downstream rib 140 and the upstream rib 142 of one second rib 14a, the curvature of the downstream rib 140 is set to be larger than the curvature of the upstream rib 142.

Thus, the overall shape of the second ribs 14a is almost an S shape including a straight line, in other words, the shape of a letter S elongated lengthwise. The extending directions of the second ribs 14a described above are represented by the extending directions of the middle ribs 141.

The angular differences between the direction of the downstream ends of the downstream ribs 140 and the direction of the upstream ends of the upstream ribs 142 and the extending direction F3 of the flow paths in the first counter-flow portion 10 are smaller than the angular differences between the directions of the middle ribs 141 and the extending direction F3. Specifically, the downstream ends of the downstream ribs 140 are almost perpendicular to the fifth edge 1e constituting the first outlet 13.

The direction of the upstream end of each upstream rib 142 is at an angle nearly parallel to the extending direction F3 of the flow paths in the first counter-flow portion 10. Like the downstream rib 122 of the first rib 12a illustrated in FIG. 7, the upstream end of each upstream rib 142 does not extend to the first counter-flow portion 10, and faces the downstream edge of the first counter-flow portion 10 across a gap. A virtual extension line of the single-R shape of each upstream rib 142 touches a straight line indicating the extending direction F3 of the flow paths in the first counter-flow portion 10.

The downstream ribs 140 and the upstream ribs 142, which have been illustrated with the examples of the single-R arc shapes, may each have a curved shape that combines arcs having different radii R. The middle ribs 141, which have been illustrated with the example of the linear shape, may each have a slight curve as long as they are almost linear as a whole.

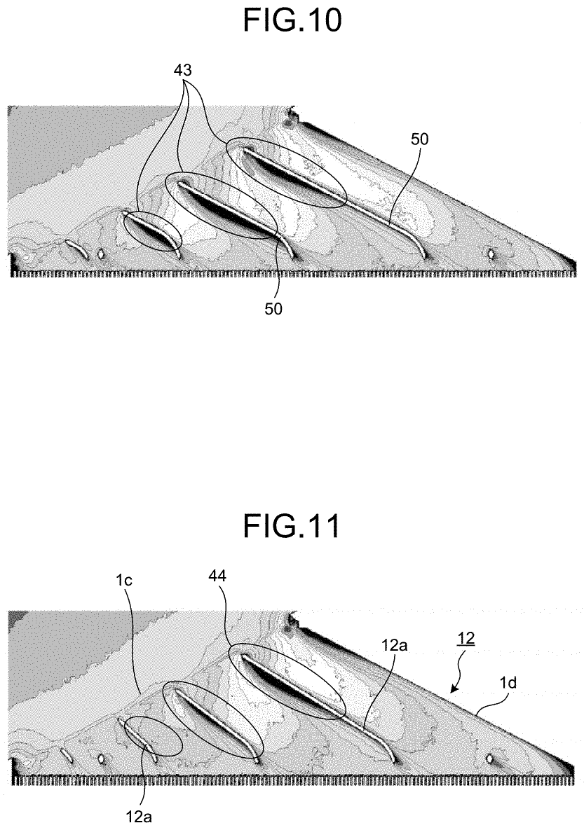

FIG. 10 is a diagram illustrating an air velocity distribution in a header portion with a rib arrangement according to a comparative example. In the comparative example, an air velocity distribution in a portion corresponding to the first header portion 12 is illustrated. A plurality of ribs 50 are arranged in parallel to each other. The flow path widths between the ribs 50 axe equal intervals along the entire lengths of the ribs 50. In the comparative example, portions of the ribs 50 corresponding to the upstream ribs are not formed in an arc shape. In the comparative example flow stagnation 43 occurs at each rib 50, which is a cause of pressure loss.

FIG. 11 is a diagram illustrating an air velocity distribution in the first header portion 12 with the rib arrangement according to the present embodiment. In FIG. 11, in order to confirm the respective effects of the angle and the end shape of each rib, the upstream rib 120 of each first rib 12a is not formed in an arc shape, and the rib angles of the first ribs 12a are set such that the above-described relationship θ1<θ2<θ3<θ4 is established. In the case of FIG. 11, stagnation 44 occurs only at the first rib 12a closest to the fourth edge 1d due to the small rib collision angle of an inflow air current, but stagnation disappears at the other first ribs 12a. Furthermore, by setting θ1<θ2<θ3<θ4, the air velocity distribution in the vicinity of the first counter-flow portion 10 is not affected, and heat-exchange efficiency is not hindered.

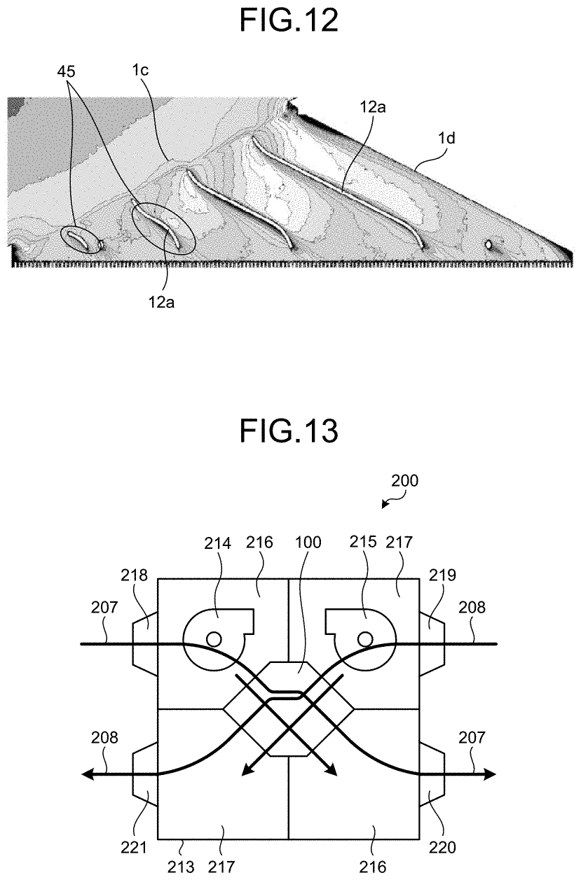

FIG. 12 is a diagram illustrating an air velocity distribution in the first header portion 12 with the rib arrangement according to the present embodiment. In FIG. 12, in order to confirm the respective effects of the angle and the end shape of each rib, the first ribs 12a are made the same in rib angle as in the comparative example, and the upstream rib 120 of each first rib 12a is formed in an arc shape. In the case of FIG. 12, air flows along the ribs at all the first ribs 12a, and stagnation disappears. However, at the two first ribs 12a far from the fourth edge 1d, stagnation 45 occurs in flow, compared to the distribution around the ribs at the same places in FIG. 11. The stagnation 45 can be eliminated by setting the rib angles to θ1<θ2<θ3<θ4 as illustrated in FIG. 11.

Thus, according to the embodiment, the plurality of ribs on each header portion are formed to establish the relationship θ1<θ2<θ3<θ4 or the relationship φ1<φ2<φ3<φ4. Consequently, in the header portion, the flow path widths of the plurality of flow paths formed by the plurality of ribs are larger near the counter-flow portion than near the inlet. This can reduce pressure loss in the header portion and allows air currents to uniformly flow into the counter-flow portion.

In this embodiment, the upstream ribs of the inlet-side header are formed in an arc shape so that the upstream ends of the upstream ribs are perpendicular to the edge constituting the inlet. Consequently, the inflow direction of an air current at the inlet agrees with the direction of the upstream ribs of the inlet-side header, reducing pressure loss at the inlet. The downstream ribs of the outlet-side header are formed in an arc shape so that the downstream ends of the downstream ribs are perpendicular to the edge constituting the outlet.

Consequently, the outflow direction of an air current at the outlet agrees with the direction of the downstream ribs of the outlet-side header, reducing pressure loss at the outlet.

In this embodiment, the extending directions of the upstream ribs are made closer to the extending direction of the flow paths in the counter-flow portion than the extending directions of the middle ribs, and the extending directions of the downstream ribs are made closer to the extending direction of the flow paths in the counter-flow portion than the extending directions of the middle ribs. This can reduce pressure loss in the header portions.

In this embodiment, the downstream end of the downstream rib 122 of each first rib 12a faces the upstream edge of the first counter-flow portion 10 across the gap Δt, the downstream rib 122 of each first rib 12a has an arc shape, the virtual extension line 125 of the downstream rib 122 of each first rib 12a touches the extending direction F3 of the flow paths in the first counter-flow portion 10, the upstream end of the upstream rib 142 of each second rib 14a faces the downstream edge of the first counter-flow portion 10 across the gap, the upstream rib 142 of each second rib 14a has an arc shape, and the virtual extension line of the upstream rib 142 of each second rib 14a touches the extending direction F3 of the flow paths in the first counter-flow portion 10. This can reduce pressure loss in flows from the first ribs 12a to the first counter-flow portion 10 and flows from the first counter-flow portion 10 to the second ribs 14a.

The downstream ribs 122 of the plurality of first ribs 12a of the first header portion 12 have arc shapes of different radii and increase in curvature with increasing distance from the fourth edge 1d, and the upstream ribs 142 of the plurality of second ribs 14a of the second header portion 14 have arc shapes of different radii and increase in curvature with increasing distance from the sixth edge 1f. This achieves uniform flows from the first ribs 12a to the first counter-flow portion 10 and achieves uniform flows from the first counter-flow portion 10 to the second ribs 14a.

When the heat-exchange element 100 in FIG. 1 is viewed as a plan view, in the heat-exchange element 100 in FIG. 1, the first partition plates 1 form the first flow paths from the lower left to the upper right, and the second partition plates 2 form the second flow paths from the lower right to the upper left. In another embodiment, the first partition plates 1 may form the first flow paths from the upper left to the lower right, and the second partition plates 2 may form the second flow paths from the upper right to the lower left, or the first partition plates 1 may form the first flow paths from the lower right to the upper left, and the second partition plates 2 may form the second flow paths from the lower left to the upper right, or the first partition plates 1 may form the first flow paths from the upper right to the lower left, and the second. partition plates 2 may form. the second flow paths from the upper left to the lower right.

Next, a heat-exchange ventilation apparatus 200 including the heat-exchange element 100 will be described. FIG. 13 is a conceptual diagram illustrating the heat-exchange ventilation apparatus 200 in which the heat-exchange element 100 is installed.

The heat-exchange ventilation apparatus 200 includes an air supply fan 214, an air exhaust fan 215, the heat-exchange element 100, and a casing 213.

The casing 213 is a box-shaped member that houses the air supply fan 214, the air exhaust fan 215, and the heat-exchange element 100. A supply air passage 216 through which a first air current 207 passes and an exhaust air passage 217 through which a second air current 208 passes are provided in the casing 213. The first air current 207 is a supply air current from the outside to the inside of a room. The second air current 208 is an exhaust air current from the inside to the outside of the room. A supply air outlet 220 and an exhaust air inlet 219 are provided in an interior-side side surface of the casing 213. A supply air inlet 218 and an exhaust air outlet 221 are provided in an exterior-side side surface of the casing 213.

The air supply fan 214 is disposed in the supply air passage 216. The air supply fan 214 takes outside air from the supply air inlet 218 into the supply air passage 216, generating the first air current 207. The first air current 207 flows through the supply air passage 216 and is blown into the room from the supply air outlet 220. The air supply fan 214 generates the first air current 207 from the outside to the inside of the room.

The air exhaust fan 215 is disposed in the exhaust air passage 217. The air exhaust fan 215 takes inside air from the exhaust air inlet 219 into the exhaust air passage 217, generating the second air current 208. The second air current 208 flows through the exhaust air passage 217 and is blown to the outside of the room from the exhaust air outlet 221. The air exhaust fan 215 generates the second air current 208 from the inside to the outside of the room.

The heat-exchange element 100 is provided at the position of the intersection of the supply air passage 216 and the exhaust air passage 217. The heat-exchange element 100 performs total heat exchange between the first air current 207 flowing through the supply air passage 216 and the second air current 208 flowing through the exhaust air passage 217. The heat-exchange ventilation apparatus 200 recovers sensible beat and latent heat of an exhaust air current from inside the room by total heat exchange in the heat-exchange element 100, and transfers the recovered sensible heat and latent heat to a supply air current. Further, the heat-exchange ventilation apparatus 200 recovers sensible heat and latent heat of a supply air current from outside the room by total heat exchange in the heat-exchange element 100, and transfers the recovered sensible heat and latent heat to an exhaust air current. The heat-exchange ventilation apparatus 200 can improve cooling and heating efficiency and dehumidification and humidification efficiency in the room, reducing energy used for air conditioning in the room. The heat-exchange element 100 may be configured to transfer only sensible heat between an exhaust air current and a supply air current.

The configuration described in the above embodiment illustrates an example of the subject natter of the present disclosure, and can be combined with another known art, and can be partly omitted or changed without departing from the scope of the present disclosure.

### REFERENCE SIGNS LIST

1 first partition plate; 1a first edge; 1b second edge; 1c third edge; 1d fourth edge; 1e fifth edge; 1f sixth edge; 2 second partition plate; 2a seventh edge; 2b eighth edge; 2c ninth edge; 2d tenth edge; 2e eleventh edge; 2f twelfth edge; 10 first counter-flow portion; 11 first inlet; 12 first header portion; 12a first rib; 13 first outlet; 14 second header portion; 14a second rib; 20 second counter-flow portion; 21 second inlet; 22 fourth header portion; 22a fourth rib; 23 second outlet; 24 third header portion; 24a third rib; 100 heat-exchange element; 120, 142 upstream rib; 121, 141 middle rib; 122, 140 downstream rib; 200 heat-exchange ventilation apparatus.

1. A heat-exchange element comprising hexagonal first partition plates and hexagonal second partition plates stacked alternately, a plurality of first flow paths that are each formed between a front surface of one of the first partition plates and a back surface of an adjacent one of the second partition plates and through each of which air flows from a first inlet to a first outlet, and a plurality of second flow paths that are each formed between a back surface of one of the first partition plates and a front surface of an adjacent one of the second partition plates and through each of which air flows from a second inlet to a second outlet, wherein
each of the first partition plates includes
a first counter-flow portion disposed in a region sandwiched between a first edge and a second edge that are opposite edges of a hexagon, the first counter-flow portion including a plurality of third flow paths extending in parallel to the first edge and the second edge,
a first header portion disposed in a region enclosed by a third edge and a fourth edge of the hexagon disposed on one side of the first edge and the second edge and the first counter-flow portion, the first header portion including a plurality of first ribs extending from the third edge that is an edge adjacent to the first edge, of the third edge and the fourth edge, along the fourth edge toward the first counter-flow portion, and
a second header portion disposed in a region enclosed by a fifth edge and a sixth edge of the hexagon disposed on an opposite side of the first edge and the second edge and the first counter-flow portion, the second header portion including a plurality of second ribs extending from the fifth edge that is an edge adjacent to the second edge, of the fifth edge and the sixth edge, along the sixth edge toward the first counter-flow portion,
each of the second partition plates includes
a second counter-flow portion disposed in a region sandwiched between a seventh edge and an eighth edge that are opposite edges of a hexagon, the second counter-flow portion including a plurality of fourth flow paths extending in parallel to the seventh edge and the eighth edge,
a third header portion disposed in a region enclosed by a ninth edge and a tenth edge of the hexagon disposed on one side of the seventh edge and the eighth edge and the second counter-flow portion, the third header portion including a plurality of third ribs extending from the tenth edge that is an edge adjacent to the eighth edge, of the ninth edge and the tenth edge, along the ninth edge toward the second counter-flow portion, and
a fourth header portion disposed in a region enclosed by an eleventh edge and a twelfth edge of the hexagon disposed on an opposite side of the seventh edge and the eighth edge and the second counter-flow portion, the fourth header portion including a plurality of fourth ribs extending from the twelfth edge that is an edge adjacent to the seventh edge, of the eleventh edge and the twelfth edge, along the eleventh edge toward the second counter-flow portion,
the first partition plates and the second partition plates are stacked alternately such that the first edge is placed on the seventh edge, and the third edge is placed on the ninth edge, the first inlet is a space between the third edge and the ninth edge, the first outlet is a space between the fifth edge and the eleventh edge, the second inlet is a space between the twelfth edge and the sixth edge, the second outlet is a space between the tenth edge and the fourth edge, the first flow paths are formed by the first ribs, the third flow paths, and the second ribs, and the second flow paths are formed by the fourth ribs, the fourth flow paths, and the third ribs,
an extending direction of a fifth rib that is one of the plurality of first ribs of the first header portion is closer to an extending direction of the third flow paths than an extending direction of a sixth rib that is a rib of the plurality of first ribs closer to the fourth edge than the fifth rib,
an extending direction of a seventh rib that is one of the plurality of second ribs of the second header portion is closer to the extending direction of the third flow paths than an extending direction of an eighth rib that is a rib of the plurality of second ribs closer to the sixth edge than the seventh rib,
an extending direction of a ninth rib that is one of the plurality of third ribs of the third header portion is closer to an extending direction of the fourth flow paths than an extending direction of a tenth rib that is a rib of the plurality of third ribs closer to the ninth edge than the ninth rib, and
an extending direction of an eleventh rib that is one of the plurality of fourth ribs of the fourth header portion is closer to the extending direction of the fourth flow paths than an extending direction of a twelfth rib that is a rib of the plurality of fourth ribs closer to the eleventh edge than the eleventh rib.

2. The heat-exchange element according to claim 1, wherein
extending directions of the plurality of first ribs of the first header portion become closer to the extending direction of the third flow paths with increasing distance from the fourth edge,
extending directions of the plurality of second ribs of the second header portion become closer to the extending direction of the third flow paths with increasing distance from the sixth edge,
extending directions of the plurality of third ribs of the third header portion become closer to the extending direction of the fourth flow paths with increasing distance from the ninth edge, and
extending directions of the plurality of fourth ribs of the fourth header portion become closer to the extending direction of the fourth flow paths with increasing distance from the eleventh edge.

3. The heat-exchange element according to claim 1, wherein
each of the first ribs, the second ribs, the third ribs, and the fourth ribs includes a middle rib, an upstream rib disposed upstream of the middle rib, and a downstream rib disposed downstream of the middle rib, the middle rib has a linear shape, and the upstream rib and the downstream rib have a curved shape.

4. The heat-exchange element according to claim 3, wherein
an extending direction of the upstream rib is closer to the extending direction of the third flow paths than an extending direction of the middle rib, and
an extending direction of the downstream rib is closer to the extending direction of the third flow paths than the extending direction of the middle rib.

5. The heat-exchange element according to claim 4, wherein
the first ribs, the second ribs, the third ribs, and the fourth ribs have an S shape including a straight line or an inverted S shape including a straight line.

6. The heat-exchange element according to claim 3, wherein
an upstream end of the upstream rib of each of the first ribs is perpendicular to the third edge,
a downstream end of the downstream rib of each of the second ribs is perpendicular to the fifth edge,
a downstream end of the downstream rib of each of the third ribs is perpendicular to the tenth edge, and
an upstream end of the upstream rib of each of the fourth ribs is perpendicular to the twelfth edge.

7. The heat-exchange element according to claim 3, wherein
a downstream end of the downstream rib of each of the first ribs faces an upstream edge of the first counter-flow portion across a gap, the downstream rib of each of the first ribs has an arc shape, and a virtual extension line of the downstream rib of each of the first ribs touches a straight line indicating the extending direction of the third flow paths,
an upstream end of the upstream rib of each of the second ribs faces a downstream edge of the first counter-flow portion across a gap, the upstream rib of each of the second ribs has an arc shape, and a virtual extension line of the upstream rib of each of the second ribs touches a straight line indicating the extending direction of the third flow paths,
an upstream end of the upstream rib of each of the third ribs faces a downstream edge of the second counter-flow portion across a gap, the upstream rib of each of the third ribs has an arc shape, and a virtual extension line of the downstream upstream rib of each of the third ribs touches a straight line indicating the extending direction of the fourth flow paths, and
a downstream end of the downstream rib of each of the fourth ribs faces an upstream edge of the second counter-flow portion across a gap, the downstream rib of each of the fourth ribs has an arc shape, and a virtual extension line of the downstream rib of each of the fourth ribs touches a straight line indicating the extending direction of the fourth flow paths.

8. The heat-exchange element claim 3, wherein
a curvature of the upstream rib of the first rib is larger than a curvature of the downstream rib of the first rib,
a curvature of the upstream rib of the fourth rib is larger than a curvature of the downstream rib of the fourth rib,
a curvature of the downstream rib of the second rib is larger than a curvature of the upstream rib of the second rib, and
a curvature of the downstream rib of the third rib is larger than a curvature of the upstream rib of the third rib.

9. The heat-exchange element according to claim 3, wherein
the upstream ribs of the plurality of first ribs of the first header portion have arc shapes of the same radius,
the downstream ribs of the plurality of first ribs of the first header portion have arc shapes of different radii and increase in curvature with increasing distance from the fourth edge,
the downstream ribs of the plurality of second ribs of the second header portion have arc shapes of the same radius, and
the upstream ribs of the plurality of second ribs of the second header portion have arc shapes of different radii and increase in curvature with increasing distance from the sixth edge.

10. The heat-exchange element according to claim 3, wherein
the downstream ribs of the plurality of third ribs of the third header portion have arc shapes of the same radius,
the upstream ribs of the plurality of third ribs of the third header portion have arc shapes of different radii and increase in curvature with increasing distance from the ninth edge,
the upstream ribs of the plurality of fourth ribs of the fourth header portion have arc shapes of the same radius, and
the downstream ribs of the plurality of fourth ribs of the fourth header portion have arc shapes of different radii and increase in curvature with increasing distance from the eleventh edge.

11. A heat-exchange ventilation apparatus in which the heat-exchange element according to claim 1 is installed.
